(19) United States
(12) Patent Application Publication
(10) Pub. No.: US 2024/0255625 A1
(43) Pub. Date: Aug. 1, 2024

(54) MULTI-CHANNEL LIGHT DETECTION AND RANGING SYSTEM

(71) Applicant: LightIC Technologies HK Limited, Hong Kong (CN)

(72) Inventors: Guomin JIANG, Santa Clara, CA (US); Hasitha JAYATILLEKA, Santa Clara, CA (US); Zhi LI, Santa Clara, CA (US); Ziyun KONG, Santa Clara, CA (US); Tianbo SUN, Santa Clara, CA (US); Jie SUN, Santa Clara, CA (US)

(21) Appl. No.: 18/633,325

(22) Filed: Apr. 11, 2024

Related U.S. Application Data
(63) Continuation of application No. PCT/CN2023/128262, filed on Oct. 31, 2023.

(30) Foreign Application Priority Data
Oct. 31, 2022 (CN) 202211345820.5

(51) Int. Cl. G01S 7/4911; G01S 7/4914; G01S 7/499

(52) U.S. Cl. CPC G01S 7/4911; G01S 7/4914; G01S 7/499

(57) ABSTRACT

A multi-channel LiDAR system is provided, which includes a laser light source configured to generate a laser beam; a 1×N optical transmission apparatus including one input terminal and N output terminals, and configured to receive the emitted light beam and transmit the same to the i-th output terminal; N light-emitting terminals connected with the N output terminals, where the i-th light-emitting terminal is configured to emit the emitted light beam, and the emitted light beam is reflected to generate a reflected light beam; N light-emitting terminals connected to the N output terminals, where an i-th light-receiving terminal is configured to receive the reflected light beam, and the reflected light beam is received by the 1×N optical transmission apparatus and transmitted from the i-th output terminal to the input terminal; and a detection apparatus, connected to the input terminal, and configured to detect the reflected light beam.

### CROSS-REFERENCE TO RELATED APPLICATION

This application is a continuation of PCT Application No. PCT/CN2023/128262 filed on Oct. 31, 2023, which claims a priority to Chinese Patent Application No. 202211345820.5 filed on Oct. 31, 2022, the disclosures of which are incorporated in their entirety by reference herein.

### TECHNICAL FIELD

The present disclosure relates to the technical field of Light Detection And Ranging (LiDAR), and in particular, relates to a multi-channel LiDAR.

### BACKGROUND

A LiDAR is a radar system that emits a laser beam to detect a feature quantity such as a position and a speed of a target. An operational principle of the LiDAR is to transmit a detection signal to the target, then compare a received signal reflected from the target with the transmitted signal, and after appropriate processing, related information of the target, such as parameters of a target distance, an orientation, a height, a speed, an attitude, or even a shape of the target may be obtained, so as to detect, track and identify targets such as an aircraft and a missile. Laser radars are now widely deployed in different scenarios including automated vehicles. The LiDAR may actively estimate a distance and a speed of an environmental feature when a scenario is scanned, and generate a point location cloud indicating a three-dimensional shape of an environmental scenario. A LiDAR is one of core sensors widely used in an autonomous driving scenario, and may be configured to collect three-dimensional information of an external environment. According to a detection mechanism of the LiDAR, there are mainly two types of LiDAR which are a Time of Flight (ToF) LiDAR and a Frequency Modulated Continuous Wave (FMCW) LiDAR.

### SUMMARY

A multi-channel Light Detection and Ranging (LiDAR) system is provided in some embodiments of the present disclosure. The multi-channel LiDAR system includes: a laser light source configured to generate a laser light, wherein at least a portion of the laser light being is used as an emitted light beam; an 1×N optical transmission apparatus, including one input terminal and N output terminals and configured to receive the emitted light beam and transmit the emitted light beam from the input terminal to an i-th output terminal of the N output terminals, wherein N and i are both positive integers, N≥2, and 1≤i≤N; a polarization splitter-rotator between the laser light source and the 1×N light transmission apparatus; N light-emitting terminals connected to the N output terminals in one-to-one correspondence, wherein an i-th light-emitting terminal of the N light-emitting terminals is configured to emit the emitted light beam, and the emitted light beam is reflected to generate a reflected light beam after the emitted light beam encounters an obstacle; N light-receiving terminals connected to the N output terminals in one-to-one correspondence, wherein an i-th light-receiving terminal is configured to receive the reflected light beam, and the reflected light beam is received by the 1×N optical transmission apparatus and transmitted from the i-th output terminal to the input terminal; and a detection apparatus, connected to the polarization splitter-rotator, and configured to detect the reflected light beam.

In some embodiments, the laser light is a frequency-sweep light beam, and the multi-channel LiDAR system further includes: a beam splitter configured to split the frequency-sweep beam into the emitted beam and a local-oscillation light beam, wherein frequency modulation waveforms of the emitted light beam and the local-oscillation light beam are identical; wherein the detection apparatus includes: a mixer configured to receive the local-oscillation light beam and the reflected light beam, and mix the local-oscillation light beam and the reflected light beam to obtain a mixed beam; and a detector configured to receive the mixed beam and detect a beat frequency between the local-oscillation light beam and the reflected light beam to obtain a detection result.

In some embodiments, the emitted light beam is a Transverse Electric (TE) mode beam, the reflected light beam generated after the TE mode beam is incident onto an obstacle includes a Transverse Magnetic (TM) mode beam, the polarization splitter-rotator is configured to transform the TM mode beam into a TE mode beam.

In some embodiments, a light-emitting terminal of the N light-emitting terminals and a light-receiving terminal, corresponding to the light-emitting terminal, of the N light-receiving terminals are coaxial.

In some embodiments, the one input terminal of the 1×N optical transmission apparatus is connected to the N output terminals of the 1×N optical transmission apparatus in a time-division manner.

In some embodiments, the multi-channel LiDAR system further includes: a lens assembly configured to perform collimation and deflection on the emitted light beam emitted by an i-th light-emitting terminal of the N light-emitting terminals, and perform focusing on the reflected light beam to be coupled into an i-th light-receiving terminal of the N light-receiving terminals; and a beam-scanning guiding apparatus on a side, away from the i-th light-emitting terminal and the i-th light-receiving terminal, of the lens assembly and configured to adjust an emergent direction of the emitted light beam emitted from the i-th light-emitting terminal over time to achieve beam-scanning.

In some embodiments, the 1×N optical transmission apparatus includes: M stages of cascaded optical switch units, wherein each of the optical switch units includes one input terminal and a plurality of output terminals, an output terminal of an optical switch unit in a j-th stage is connected to an input terminal of an optical switch unit 21 in a (j+1)-th stage in one-to-one correspondence, M and j are positive integers, M≥2, 1≤j<M; an input terminal of an optical switch unit in a first stage is the one input terminal of the 1×N optical transmission apparatus, output terminals of optical switch units in the M-th stage are the N output terminals of the 1×N optical transmission apparatus.

In some embodiments, a quantity of output terminals of a first optical switch unit and a quantity of output terminals of a second optical switch unit in the same stage of the M stages are same or different.

In some embodiments, a quantity of output terminals of an optical switch unit and a quantity of output terminals of an optical switch unit in two adjacent stages of the M stages are same or different.

In some embodiments, the optical switch units include at least one of an Electro-Optic (EO) switch or a Thermo-Optic (TO) switch.

In some embodiments, each of the optical switch units includes a first input terminal, a first output terminal and a second output terminal, and can be switched between a first switch state and a second switch state; when the each of the optical switch units is in the first switch state, an optical path is formed between the first input terminal and the first output terminal and light blocking is formed between the first input terminal and the second output terminal; when the each of the optical switch units is in the second switch state, an optical path is formed between the first input terminal and the second output terminal and light blocking is formed between the first input terminal and the first output terminal.

Compared with the related art, the above solutions of the embodiments of the present disclosure have at least the following beneficial effects.

The multi-channel LiDAR system is provided with a 1×N optical transmission apparatus which is configured to transmit the emitted light beam and transmit the reflected light beam, and a plurality of channels of the multi-channel LiDAR system share a laser light source, a detection apparatus, and the like, to reduce components of the multi-channel LiDAR system and reduce costs.

### BRIEF DESCRIPTION OF THE DRAWINGS

The accompanying drawings are incorporated in and constitute a part of this specification. The drawings illustrate embodiments of the present disclosure, and the drawings and the description serve to explain the principles of the present disclosure. Obviously, the accompanying drawings in the following description are merely some embodiments of the present disclosure, and other drawings may also be obtained according to these accompanying drawings by a person of ordinary skill in the art without creative efforts. In the drawings:

FIG. 1 is a schematic structural diagram of a multi-channel LiDAR according to some embodiments of the present disclosure;

FIG. 2 is a schematic structural diagram of a 1×n optical transmission apparatus according to some embodiments of the present disclosure;

FIG. 3 is another schematic structural diagram of a multi-channel LiDAR provided by some embodiments of the present disclosure; and

FIG. 4 is a waveform diagram of a transmitted beam and a received beam in a FWCW LiDAR provided in the present disclosure.

### DETAILED DESCRIPTION

In order to make objectives, technical solutions, and advantages of the present disclosure clearer, the present disclosure will be further described in detail below with reference to the accompanying drawings, and obviously, the described embodiments are merely some but not all of the embodiments of the present disclosure. All other embodiments obtained by a person of ordinary skill in the art based on the embodiments of the present disclosure without creative efforts shall fall within the protection scope of the present disclosure.

The terminology used in the embodiments of the present disclosure is for the purpose of describing particular embodiments only and is not intended to be limiting of the present disclosure. Singular forms “a”, “the” and “an” used in the embodiments of the present disclosure and the appended claims are also intended to include plural forms, unless the context clearly indicates other meanings, and “a plurality of” generally includes at least two.

It should be understood that the term “and/or” used herein is merely an association relationship describing associated objects, indicating that three relationships may exist, for example, A and/or B may indicate that A exists alone, A and B exist simultaneously, and B exists alone. In addition, the character “/” in this specification generally indicates an “or” relationship between the associated objects.

It should be understood that although the terms “first”, “second”, “third”, etc. may be used in the embodiments of the present disclosure, these terms should not be limited. These terms are only used to distinguish similar objects, but not an order. For example, first may also be referred to as second, and similarly, second may also be referred to as first, without departing from the scope of the embodiments of the present disclosure.

It should also be noted that the terms “include”, “including” or any other variations thereof are intended to cover a non-exclusive inclusion, so that a product or a device including a series of elements not only includes those elements, but also includes other elements not explicitly listed, or further includes elements inherent to such a product or device. Without more restrictions, an element after the phrase “including” does not exclude the presence of additional identical elements in the product or device that includes the element.

The present disclosure provides a multi-channel LiDAR system which includes: a laser light source configured to generate a laser light, at least a part of the laser light being used as an emitted light beam; 1×N optical transmission apparatus, having one input terminal and N output terminal and configured to receive the emitted light beam and transmit the emitted light beam from the input terminal to the i-th output terminal, where N and i are both positive integers, N≥2, and 1≤i≤N; N light-transmitting terminal, connected to the N output terminals in an one-to-one correspondence manner, where the i-th light-transmitting terminal is configured to transmit the emitted light beam, and the emitted light beam is reflected to generate a reflected light beam after encountering an obstacle; N light-receiving terminals, connected to the N output terminals in an one-to-one correspondence manner, where the i-th light-receiving terminal is configured to receive the reflected light beam, the reflected light beam is configured to be received by the 1×N optical transmission apparatus, and is transmitted to the input terminal from the i-th output terminal; and a detection apparatus, connected to the input terminal and configured to detect the reflected light beam.

The multi-channel LiDAR system of the present disclosure is provided with a 1×N optical transmission apparatus which is used to transmit the emitted light beam and receive the reflected light beam, and has a plurality of channels which share a common laser light source and the detection apparatus, thereby reducing components of the multi-channel LiDAR system and reducing costs.

Optional embodiments of the present disclosure will be described in detail below with reference to the accompanying drawings.

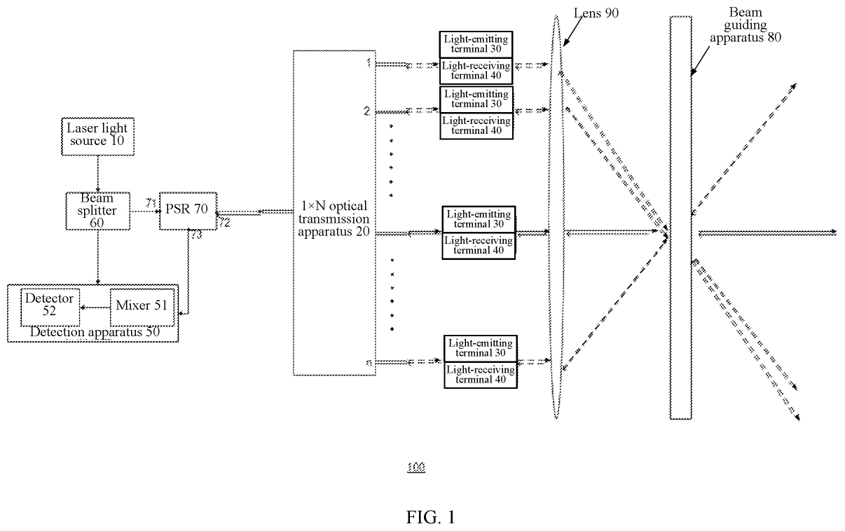

FIG. 1 is a schematic structural diagram of a multi-channel LiDAR system according to some embodiments of the present disclosure. As shown in FIG. 1, the present disclosure provides a multi-channel LiDAR system 100, which includes a laser light source 10, a 1×N optical transmission apparatus 20, N light-emitting terminals 30, N light-receiving terminals 40 and a detection apparatus 50, wherein the multi-channel LiDAR system can provide multi-line laser scanning, and each channel corresponds to a specific scanning area, so that rapid scanning detection can be achieved.

The laser light source 10 is configured to generate a laser light, and at least a portion of the laser light is used as an emitted beam to perform detection, for example, detection of a distance and/or a speed of an obstacle. The laser light source 10 is, for example, a semiconductor laser light source, and may be integrated on a semiconductor chip. The laser light source 10 may be directly modulated by a chirp signal. That is, a driving signal for controlling the laser light source 10 may be input to the laser light source 10 at an intensity changing with time, so that the laser light source 10 generates and outputs a frequency-sweep beam, that is, a light beam whose frequency changes in a predetermined range. In some embodiments, the laser light source 10 may further include a modulator that receives a modulation signal, and the modulator may be configured to modulate the light beam based on the modulation signal, so that the laser light source 10 generates and outputs the frequency-sweep beam, that is, a light beam whose frequency changes in a predetermined range. In some embodiments, the laser light source 10 may further include an external laser light source, the external laser light source is connected to a semiconductor chip through an optical path (for example, an optical fiber), a frequency of the laser beam output by the laser light source 10 when the laser light source 10 is not modulated is substantially constant, referred to as the frequency of an unmodulated light beam, for example, 100-300 THz. The laser light source 10 may output the frequency-sweep beam after modulation, and the frequency range of the frequency-sweep beam is related to the frequency of the unmodulated light beam.

The 1×N optical transmission apparatus 20 has one input terminal and N output terminals, and is configured to receive the emitted light beam and transmit the emitted light beam from the input terminal to the i-th output terminal, wherein both N and i are positive integers, N≥2, 1≤i≤N, the input terminal is configured to receive the emitted light beam used for detection, the N output terminals correspond to N laser channels, and the 1×N optical transmission apparatus 20 may guide the emitted light beam to one of the N laser channels, so that the emitted light beam is emitted from the laser channel. By using this design, a time division manner can be used to enable the emitted light beam to be emitted sequentially from the N laser channels, to realize multi-channel detection, that is, multi-line laser detection is realized. Emergent directions of the emitted light beam from different channels may be the same or different.

The N light-emitting terminals 30 are connected to the N output terminals in one-to-one correspondence, and when the 1×N optical transmission apparatus 20 guides the emitted light beam to the i-th output terminal, the i-th light-emitting terminal is configured to enable the emitted light beam to be emitted, and the emitted light beam is reflected to generate the reflected light beam after encountering an obstacle. For example, the N light-emitting terminals 30 are integrated on the semiconductor chip, and may be configured to emit the emitted light beam at a predetermined angle, and exit angles of the emitted light beam at the N light-emitting terminals 30 may be the same or different. When the emitted light beam encounters an obstacle during propagation, the reflected light beam may be generated on the surface of the obstacle.

The N light-receiving terminals 40 correspond to the N output terminals in one-to-one correspondence. After the 1×N optical transmission apparatus 20 guides the emitted light beam to the i-th output terminal, the i-th light-receiving terminal is configured to receive the reflected light beam, and the reflected light beam is configured to be received by the 1×N optical transmission apparatus and guided from the i-th output terminal to the input terminal. The reflected light beam may be received by the i-th light-receiving terminal 40. The light-receiving terminals 40 may also be, for example, integrated on the semiconductor chip, and the i-th light-receiving terminal 40 is configured to receive the reflected light beam generated by the emitted light beam emitted by the light-emitting terminal 30 corresponding to the i-th light-receiving terminal 40.

The detection apparatus 50 is connected to the input terminal, for example, integrated on a semiconductor chip, and configured to detect the reflected light beam, so as to obtain a detection result, for example, a distance or a speed of an obstacle.

The multi-channel LiDAR system 100 of the present disclosure is provided with a 1×N optical transmission apparatus, that is, is configured to transmit the emitted light beam, and is further configured to transmit the reflected light beam, and the plurality of channels of the multi-channel LiDAR system share a common laser light source, a common detection apparatus, and the like, and compared with each channel corresponding to one independent laser light source and one independent detection apparatus in the related art, components of the multi-channel LiDAR system may be reduced, thereby reducing costs.

In the art, the LiDAR system mainly includes following two technical routes according to a detection principle: TOF (Time of Flight) and FMCW (Frequency-Modulated Continuous Wave). A distance measurement principle of the TOF is that a distance is measured and calculated by multiplying the flight time of a light pulse between a target object and a laser radar, and the laser radar of the TOF adopts a pulse amplitude modulation technology. Unlike the TOF, the FMCW mainly enable the reflected light beam to interfere with a local light beam by sending and receiving a continuous laser beam, measures frequency difference between the transmitted light beam and the received light beam by using a frequency mixing technology, and then calculates the distance of a target by using the frequency difference. Briefly, TOF uses time to measure the distance, while FMCW uses a frequency to measure the distance. Compared with the TOF, FMCW has the following advantages: a light beam of the TOF is easily interfered by ambient light, and anti-interference capability of a light beam of the FMCW is very strong; a signal-to-noise ratio of the TOF is too low, while a signal-to-noise ratio of the FMCW is very high, and a data amount of the TOF in a speed dimension is low, whereas the FMCW can obtain data of each pixel point in the speed dimension.

Next, the solution in the present disclosure is specifically described by taking an FMCW multi-channel LiDAR system as an example, and it can be understood that the solution in the present disclosure may also be applied to a TOF multi-channel LiDAR system.

In some embodiments, as shown in FIG. 1, a laser light source 10 generates a frequency-sweep beam, and the multi-channel LiDAR system 100 further includes a beam splitter 60. The beam splitter 60 is, for example, integrated on a semiconductor chip, and is configured to receive a frequency-sweep beam output from the laser light source 10, and further split the frequency-sweep beam into two parts, namely, an emitted light beam and a local-oscillation light beam. The emitted light beam may be transmitted to the light-emitting terminal 30 corresponding to one channel through one path in the 1×N optical transmission apparatus 10 and is emitted, the local-oscillation light beam may be transmitted to the detection apparatus 50, and the emitted light beam and the local-oscillation light beam have the same frequency at any time point, that is, frequency modulation waveforms of the emitted light beam and the local-oscillation light beam are completely the same.

In some embodiments, as shown in FIG. 1, the detection apparatus 50 includes a mixer 51 and a detector 52. The mixer 51 is, for example, integrated on a semiconductor chip, and configured to receive the local-oscillation light beam and the reflected light beam, and perform mixing on the local-oscillation light beam and the reflected light beam to obtain a mixed light beam. The detector 52 is, for example, a balance detector that receives the mixed light beam and detects a beat frequency between the local-oscillation light beam and the reflected light beam to obtain a measurement result, i.e. to obtain the distance and/or velocity of the obstacle. The beat frequency refers to a frequency difference between the local-oscillation light beam and the reflected light beam.

In some embodiments, as shown in FIG. 1, the multi-channel LiDAR system 100 further includes a polarization splitter-rotator (PSR) 70 between the beam splitter 60 and the 1×N optical transmission apparatus 20, and a TE (Transverse Electric mode) beam is emitted by the light-emitting terminal 30 after passing through the 1×N optical transmission apparatus 20. The reflected light beam generated by reflection of the TE beam after encountering the obstacle includes a TE beam and a TM (Transverse Magnetic mode) beam. The reflected light beam is received by the light-receiving terminal 40 and transmitted back to the polarization splitter-rotator 70 through the 1×N light transmission apparatus 20, and the polarization splitter-rotator 70 is further configured to convert the TM beam in the reflected light beam into a TE beam, so as to facilitate subsequent frequency-mixing. Specifically, as shown in FIG. 1, the polarization splitter-rotator 70 has a first port, a second port, and a third port, the first port 71 receives the emitted light beam emitted by the beam splitter 60, the TE beam in the emitted light beam may be output from the second port 72, and the TM beam in the emitted light beam cannot pass through the polarization splitter-rotator 70. The TE beam is emitted from one light-emitting terminal 30 of the 1×N light transmission apparatus 20. The reflected light beam generated by reflection of the TE beam after encountering the obstacle includes a TE mode beam and a TM mode beam, the reflected light beam is received by the light-receiving terminal 40 and transmitted back to the second port 72 of the polarization splitter-rotator 70 through the 1×N optical transmission apparatus 20, the TM mode beam in the reflected light beam is converted by the polarization splitter-rotator 70 into a TE mode beam output from the third port 73 and received by the detection apparatus 50.

In some embodiments, the light-emitting terminal 30 and the light-receiving terminal 40 corresponding to the light-emitting terminal 30 are of a coaxial integrated structure, for example, the light-emitting terminal 30 and the light-receiving terminal 40 of the same laser channel are of the coaxial integrated structure, such as a light emitting/receiving terminal, so as to realize coaxial transmission/reception. For example, an emitted light beam and a reflected light beam that are coaxial may be distinguished or separated by means of a polarization splitting device or a three-port circulator.

In some embodiments, the N output terminals of the 1×N optical transmission apparatus are connected to the input terminal in a time-division manner. For example, in a first time period, a first output terminal is connected to the input terminal, and a first laser channel corresponding to the first output terminal performs laser detection; in a second time period, a second output terminal is connected to the input terminal, a second laser channel corresponding to the second output terminal performs laser detection; . . . ; in a n-th time period, a n-th output terminal is connected to the input terminal, and a n-th laser channel corresponding to the n-th output terminal performs laser detection. In this way, sequential scanning of the light beam generated by the common laser light source may traverse the N laser channels to realize multi-channel detection, that is, multi-line laser detection.

In some embodiments, as shown in FIG. 1, the multi-channel LiDAR system 100 further includes a lens assembly 90 and a beam-scanning guiding apparatus 80.

The lens assembly 90 may be a lens or a lens group, and has functions of focusing and collimating; for example, the lens assembly 90 is disposed on a side, away from the 1×N light transmission apparatus, of the N light-emitting terminals 30 and the N light-receiving terminals 40, and is configured to perform collimation and deflection on the emitted light beam emitted by the i-th light-emitting terminal, and perform focusing on the reflected light beam to be coupled into the i-th light-receiving terminal.

The beam-scanning guiding apparatus 80 is on a side, away from the light-emitting terminal 30 and the light-receiving terminal 40, of the lens assembly 90, and the beam-scanning guiding apparatus 80 is configured to adjust an emergent direction of the emitted light beam emitted from the i-th light-emitting terminal over time to achieve beam-scanning. The beam-scanning guiding apparatus 80 is, for example, an optical phased array (OPA) that can direct the direction of the beam by dynamically controlling an optical properties of a surface on a microscopic scale. In other embodiments, the beam-scanning guiding apparatus 80 may further include a grating, a mirror galvanometer, a polygon mirror, a MEMS mirror, or a combination of an optical phased array (OPA) and the foregoing devices.

In some embodiments, the beam-scanning guiding apparatus 80 is, for example, on a focal plane of the lens assembly 90, so that a size of the beam-scanning guiding apparatus 80 can be as small as possible, and the cost is reduced.

In some embodiments, the multi-channel LiDAR system 100 may further include a processor, which may also be integrated on the semiconductor chip, wherein the processor may calculate the distance of the obstacle, that is, the distance between the obstacle and the multi-channel LiDAR system 100, based on the beat frequency detected by the detector 52; and when the obstacle is a moving object, the processor may further calculate the speed of the obstacle according to the beat frequency detected by the detector 52, that is, the moving speed of the obstacle relative to the multi-channel LiDAR system 100.

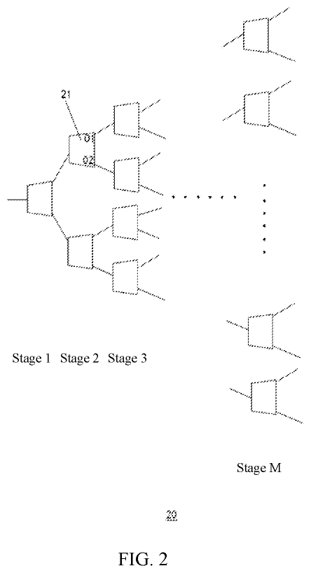

FIG. 2 is a schematic structural diagram of the 1×N optical transmission apparatus according to some embodiments of the present disclosure. As shown in FIG. 2, the 1×N optical transmission apparatus 20 is composed of multiple stages of cascaded optical switch units 21. Specifically, the 1×N optical transmission apparatus 20 includes M stages of cascaded optical switch units 21, each optical switch unit 21 includes an input terminal and a plurality of output terminals, an output terminal of an optical switch unit 21 in the j-th stage is connected to an input terminal of an optical switch unit 21 in the (j+1)-th stage in an one-to-one correspondence, M and j are positive integers, M≥2, 1≤j<M. In any two adjacent stages, the total number of output terminals of the optical switch units 21 of the previous stage is the same as the total number of input terminals of the optical switch units 21 of the next stage. An input terminal of the optical switch unit 21 in the first stage serves as the input terminal of the 1×N optical transmission apparatus, and output terminals of the optical switch units 21 in the M-th stage serves as the output terminals of the 1×N optical transmission apparatus.

The optical switch units 21 may be controlled to selectively turn on one of the input terminal and one of the plurality of output terminals. That is, the optical switch units 21 have a plurality of paths, and each path corresponds to one output terminal. As shown in FIG. 2, each optical switch unit 21 includes, for example, one input terminal and two output terminals, that is, a first output terminal O1 and a second output terminal O2, the optical switch unit 21 may be switched between a first switch state and a second switch state. When the optical switch unit 21 is in the first switch state, an optical path is formed between the input terminal and the first output terminal O1, light blocking is formed between the input terminal and the second output terminal O2; when the optical switch unit 21 is in the second switch state, an optical path is formed between the input terminal and the second output terminal O2, light blocking is formed between the input terminal and the first output terminal O1.

In some embodiments, as shown in FIG. 2, each of the optical switch units 21 has one input terminal and two output terminals. The number of the optical switch unit 21 in the first stage is 1, the input terminal of the optical switch unit 21 in the first stage is used as the input terminal of the 1×N optical transmission apparatus; the total number of output terminals of the optical switch unit 21 in the first stage is 2; the total number of the optical switch units 21 in the second stage is 2, the total number of the output terminals of the optical switch units 21 in the second stage is 4; the number of the optical switch units 21 in the third stage is 4, and the total number of output terminals of the optical switch units 21 in the third stage is 8; the number of the optical switch units 21 in the j-th stage is 2j−1, the total number of the output terminals of the optical switch units 21 in the j-th stage is 2j; the number of the optical switch units 21 in the M-th stage is 2M−1, and the total number of output terminals of the optical switch units 21 in the M-th stage is 2M. Output terminals of optical switch units 21 in the M-th stage are used as N output terminals of the 1×N optical transmission apparatus 20. Thus, N=2M, where both N and M are positive integers larger than 1.

In FIG. 2, the optical switch units 21 in each stage are sequentially numbered from top to bottom, and when first optical switch units 21 in the first stage to the M-th stage are in the first switch state at the same time, the input terminal and the first output terminal of the 1×N optical transmission apparatus forms an optical path, allowing the emitted light beam and/or the reflected light beam to pass through, that is, the first laser channel is turned on. When the first optical switch units 21 in the first stage to the (M−1)-th stage are in the first switch state and the first optical switch unit 21 in the M-th stage is in the second switch state, the input terminal and the second output terminal of the 1×N optical transmission apparatus form an optical path, allowing the emitted light beam and/or the reflected light beam to pass through, that is, the second laser channel is turned on. Similarly, when the first optical switch units 21 in the first stage to the M-th stages are in the second switch state at the same time, the input terminal and the N-th output terminal of the 1×N optical transmission apparatus form an optical path, allowing the emitted light beam and/or the reflected light beam to pass through, that is, the N-th laser channel is turned on.

As shown in FIG. 2, the number of output terminals of each optical switch unit 21 is the same in the same stage, for example, 2, and in other embodiments, the number of output terminals of different optical switch units 21 may be different in the same level.

As shown in FIG. 2, the number of output terminals of the optical switch units in a previous stage is the same as the number of output terminals of the optical switch units in a current stage, for example, 2, and in other embodiments, the number of output terminals of the optical switch units 21 in the previous stage may be different from the number of output terminals of the optical switch units in the current stage.

In some embodiments, the optical switch unit 21 includes at least one of an electronic dimming switch unit or a thermal dimming switch unit. The operation of the electric dimming switch unit is based on the Electro-Optic (EO) effect, and the operation of the thermal dimming switch unit is based on the Thermo-Optic (TO) effect. The advantage of the electronic dimming switch unit is that the switching speed of the electronic dimming switch unit is high, and the disadvantage is that the size is large and the optical loss is relatively high. The advantage of the thermal dimming switch unit is that the size is small, the optical loss can be ignored, and the disadvantage of the thermal dimming switch unit is that the switching speed of the thermal dimming switch unit is slow.

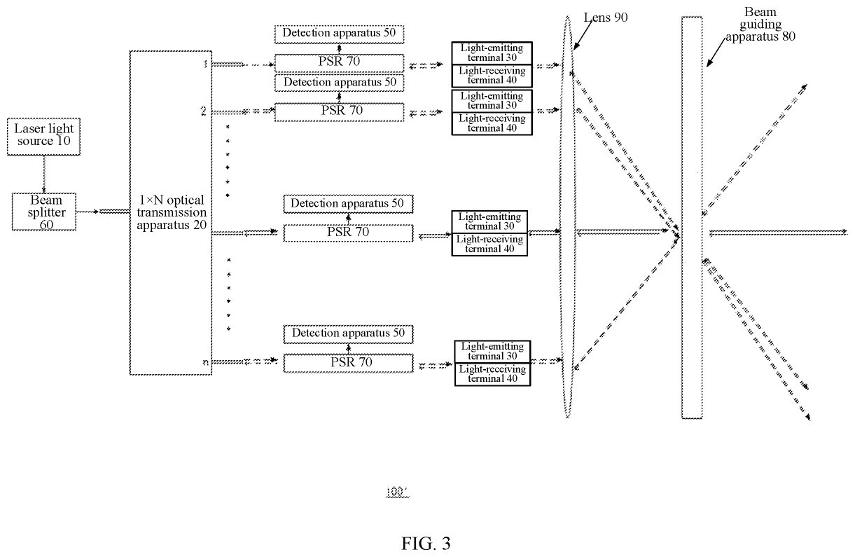

FIG. 3 is another schematic structural diagram of a multi-channel LiDAR system according to an embodiment of the present disclosure. As shown in FIG. 3, the multi-channel LiDAR system 100′ includes a laser light source 10, an beam splitter 60, a 1×N optical transmission apparatus 20, N light-emitting terminals 30, N light-receiving terminals 40, N polarization splitter-rotators 70, and N detection apparatuses 50, wherein the multi-channel LiDAR system 100′ may provide multi-line laser scanning, and each channel corresponds to a specific scanning region, so that rapid scanning and detection may be implemented.

The laser emitted by the laser light source 10 is split into an emitted light beam and a local-oscillation light beam through the beam splitter 60, the emitted light beam is output from one of the N output terminals of the 1×N optical transmission apparatus 20, the N output terminals of the 1×N optical transmission apparatus 20 respectively correspond to the N output channels, and each of the N output channels corresponds to one polarization splitter-rotator 70, one detection apparatus 50, one light-emitting terminal 30 and one light-receiving terminal 40.

The 1×N optical transmission apparatus 20 may direct the emitted light beam to one of the N output channels, i.e., N laser channels, so that the emitted light beam is emitted by the laser channel. By using this design, sequentially scanning the N laser channels by using the emitted light beam can be realized in a time division manner to realize multi-channel detection, that is, multi-line laser detection is realized. The direction of directing the emitted light beam laser by each channel may be the same or different.

For the i-th laser channel, the emitted light beam output by the i-th output terminal is emitted by the corresponding light-emitting terminal 30 after passing through the corresponding polarization splitter-rotator 70, and the emitted light beam is a TE mode beam. The reflected light beam generated by reflection of the TE mode beam after encountering the obstacle includes a TE mode beam and a TM mode beam. The reflected light beam is received by the corresponding light-receiving terminal 40 and transmitted back to the corresponding polarization splitter-rotator 70, and the polarization splitter-rotator 70 converts the TM mode beam in the reflected light beam into a TE mode beam. The TE mode beam converted and output by the polarization splitter-rotator 70 is received by the corresponding detection apparatus 50 to perform detection and analysis.

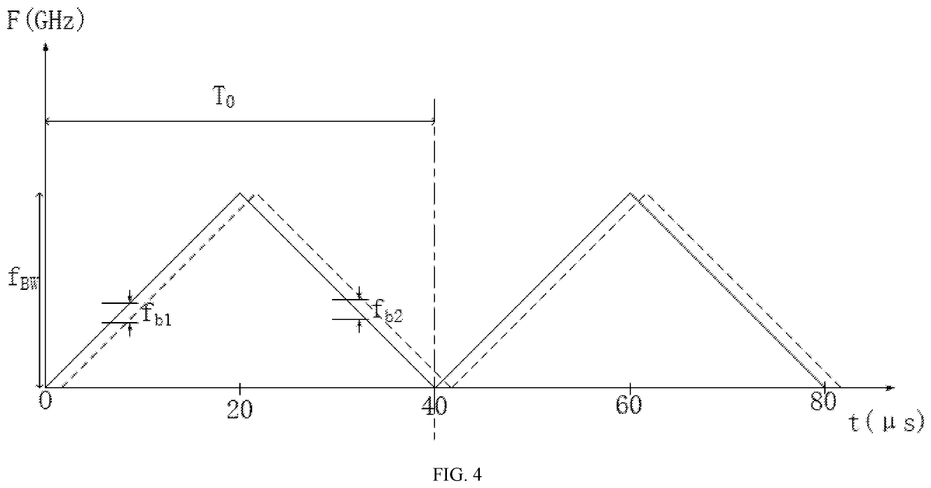

Compared with the comparative example shown in FIG. 3, the plurality of laser channels in the embodiment shown in FIG. 1 not only share the laser light source 10 and the beam splitter, but also share the polarization splitter-rotator 70 and the detection apparatus 50, thereby reducing components of the multi-channel LiDAR system and reducing costs. FIG. 4 is a waveform diagram of an emitted light beam and a received light beam in a FWCW frequency-sweep manner according to the present disclosure. As shown in FIG. 4, the frequency-sweep optical signal of the emitted light beam emitted by the multi-channel LiDAR system is represented by a solid line, the solid line reflects a curve of the frequency, changing with time, of the emitted light beam, the frequency-sweep optical signal is, for example, a periodic triangular wave signal, the reflected light signal of the reflected light beam received by the LiDAR system is represented by a dashed line. The dashed line shows the cure of the frequency, changing with time, of the received reflected light beam. The reflected optical signal is also, for example, a periodic triangular wave signal, and there is a delay between the reflected light signal and the frequency-sweep light signal.

In FIG. 4, only two frequency-sweep measurement periods are shown, and in each measurement period, the frequency-sweep light signal (i.e., the emitted light beam) includes one frequency-ascending stage and one frequency-descending stage, and correspondingly, the corresponding reflected light signal also includes one frequency-ascending stage and one frequency-descending stage.

As shown in FIG. 4, the abscissa represents time, the unit thereof is s; the ordinate represents the frequency, the unit thereof is GHz, the frequency of the emitted light beam, for example, increases from 0 to a GHz with the increase of time, and then decreases from a GHz to 0. The process repeats periodically, and correspondingly, the frequency of the received reflected light beam also increases from 0 to a GHz as the time increases, and then decreases from a GHz to 0, and the process repeats periodically, where a is a positive number. In FIG. 4, ‘a’ may be fBW, or other values.

For any measurement point, the distance R of the obstacle is determined by the following formula:

$$R = \frac{{C}_{0}}{8} \frac{{T}_{0}}{{f}_{BW}} ( {f}_{b 1} + {f}_{b 2} )$$

where TO is a preset frequency-sweep measurement period; fBW is the preset frequency-sweep bandwidth; fb1 is the beat frequency in the frequency-ascending stage, that is, the frequency difference between the emitted light beam and the reflected light beam at any time instant in the frequency-ascending stage, fb2 is the beat frequency in the frequency-descending stage, that is, the frequency difference between the emitted light beam and the reflected light beam at any time instant in the frequency-descending stage, and C0 is the speed of light.

The speed V of the obstacle meets the following relationship:

$$v = \frac{{C}_{0}}{4} \frac{1}{{f}_{0}} ( {f}_{b 1} - {f}_{b 2} )$$

where C0 is the speed of light, fb1 is the beat frequency in the frequency-ascending stage, fb2 is the beat frequency in the frequency-descending stage, f0 is the frequency of the unmodulated light beam.

Each part in the specification is described in parallel and progressively, each part focuses on differences from other parts, and the same or similar portions between the parts can be obtained by referring to each other.

Based on the above description of the disclosed embodiments, the features described in the embodiments of the present specification can be replaced or combined with each other, so that those skilled in the art can implement or use the present application. Various modifications to these embodiments will be readily apparent to those skilled in the art, and the generic principles defined herein may be implemented in other embodiments without departing from the spirit or scope of the present application. Thus, the present disclosure will not be limited to the embodiments shown herein, but is to be accorded with the widest scope consistent with the principles and novel features disclosed herein.

Finally, it should be noted that the embodiments in the present specification are described by way of example, each embodiment focuses on the differences from other embodiments, and the same or similar portions between the various embodiments can be obtained by referring to each other. For the system or the apparatus disclosed in the embodiments, since the system or the apparatus corresponds to the method disclosed in the embodiments, the description of the system and the apparatus is relatively simple, and the relevant parts can be obtained by referring to the description of the method.

Although the present disclosure has been described in detail with reference to the foregoing embodiments, those of ordinary skill in the art should understand that they can still modify the technical solutions described in the foregoing embodiments or make equivalent replacements to some of the technical features thereof, and these modifications or replacements do not depart from the spirit and the scope of the technical solutions of the embodiments of the present disclosure.

What is claimed is:

1. A multi-channel Light Detection and Ranging (LiDAR) system, comprising:
a laser light source configured to generate a laser light, wherein at least a portion of the laser light being is used as an emitted light beam;
an 1×N optical transmission apparatus, comprising one input terminal and N output terminals and configured to receive the emitted light beam and transmit the emitted light beam from the input terminal to an i-th output terminal of the N output terminals, wherein N and i are both positive integers, N≥2, and 1≤i≤N;
a polarization splitter-rotator between the laser light source and the 1×N light transmission apparatus;
N light-emitting terminals connected to the N output terminals in one-to-one correspondence, wherein an i-th light-emitting terminal of the N light-emitting terminals is configured to emit the emitted light beam, and the emitted light beam is reflected to generate a reflected light beam after the emitted light beam encounters an obstacle;
N light-receiving terminals connected to the N output terminals in one-to-one correspondence, wherein an i-th light-receiving terminal is configured to receive the reflected light beam, and the reflected light beam is received by the 1×N optical transmission apparatus and transmitted from the i-th output terminal to the input terminal; and
a detection apparatus, connected to the polarization splitter-rotator, and configured to detect the reflected light beam.

2. The multi-channel LiDAR system according to claim 1, wherein the laser light is a frequency-sweep light beam, and the multi-channel LiDAR system further comprises:
a beam splitter configured to split the frequency-sweep beam into the emitted beam and a local-oscillation light beam, wherein frequency modulation waveforms of the emitted light beam and the local-oscillation light beam are identical;
wherein the detection apparatus comprises:
a mixer configured to receive the local-oscillation light beam and the reflected light beam, and mix the local-oscillation light beam and the reflected light beam to obtain a mixed beam; and
a detector configured to receive the mixed beam and detect a beat frequency between the local-oscillation light beam and the reflected light beam to obtain a detection result.

3. The multi-channel LiDAR system according to claim 2, wherein the emitted light beam is a Transverse Electric (TE) mode beam, the reflected light beam generated after the TE mode beam is incident onto an obstacle comprises a Transverse Magnetic (TM) mode beam, the polarization splitter-rotator is configured to transform the TM mode beam into a TE mode beam.

4. The multi-channel LiDAR system according to claim 2, wherein a light-emitting terminal of the N light-emitting terminals and a light-receiving terminal, corresponding to the light-emitting terminal, of the N light-receiving terminals are coaxial.

5. The multi-channel LiDAR system according to claim 1, wherein the one input terminal of the 1×N optical transmission apparatus is connected to the N output terminals of the 1×N optical transmission apparatus in a time-division manner.

6. The multi-channel LiDAR system according to claim 1, wherein the multi-channel LiDAR system further comprises:
a lens assembly configured to perform collimation and deflection on the emitted light beam emitted by an i-th light-emitting terminal of the N light-emitting terminals, and perform focusing on the reflected light beam to be coupled into an i-th light-receiving terminal of the N light-receiving terminals; and
a beam-scanning guiding apparatus on a side, away from the i-th light-emitting terminal and the i-th light-receiving terminal, of the lens assembly and configured to adjust an emergent direction of the emitted light beam emitted from the i-th light-emitting terminal over time to achieve beam-scanning.

7. The multi-channel LiDAR system according to claim 1, wherein the 1×N optical transmission apparatus comprises:
M stages of cascaded optical switch units, wherein each of the optical switch units comprises one input terminal and a plurality of output terminals,
an output terminal of an optical switch unit in a j-th stage is connected to an input terminal of an optical switch unit 21 in a (j+1)-th stage in one-to-one correspondence, M and j are positive integers, M≥2, 1≤j<M;
an input terminal of an optical switch unit in a first stage is the one input terminal of the 1×N optical transmission apparatus, output terminals of optical switch units in the M-th stage are the N output terminals of the 1×N optical transmission apparatus.

8. The multi-channel LiDAR system according to claim 7, wherein a quantity of output terminals of a first optical switch unit and a quantity of output terminals of a second optical switch unit in the same stage of the M stages are same or different.

9. The multi-channel LiDAR system according to claim 7, wherein a quantity of output terminals of an optical switch unit and a quantity of output terminals of an optical switch unit in two adjacent stages of the M stages are same or different.

10. The multi-channel LiDAR system according to claim 7, wherein the optical switch units comprise at least one of an Electro-Optic (EO) switch or a Thermo-Optic (TO) switch.

11. The multi-channel LiDAR system according to claim 7, wherein each of the optical switch units comprises a first input terminal, a first output terminal and a second output terminal, and can be switched between a first switch state and a second switch state;
when the each of the optical switch units is in the first switch state, an optical path is formed between the first input terminal and the first output terminal and light blocking is formed between the first input terminal and the second output terminal;
when the each of the optical switch units is in the second switch state, an optical path is formed between the first input terminal and the second output terminal and light blocking is formed between the first input terminal and the first output terminal.

12. The multi-channel LiDAR system according to claim 2, wherein the one input terminal of the 1×N optical transmission apparatus is connected to the N output terminals of the 1×N optical transmission apparatus in a time-division manner.

13. The multi-channel LiDAR system according to claim 3, wherein the one input terminal of the 1×N optical transmission apparatus is connected to the N output terminals of the 1×N optical transmission apparatus in a time-division manner.

14. The multi-channel LiDAR system according to claim 2, wherein the multi-channel LiDAR system further comprises:
a lens assembly configured to perform collimation and deflection on the emitted light beam emitted by an i-th light-emitting terminal of the N light-emitting terminals, and perform focusing on the reflected light beam to be coupled into an i-th light-receiving terminal of the N light-receiving terminals; and
a beam-scanning guiding apparatus on a side, away from the i-th light-emitting terminal and the i-th light-receiving terminal, of the lens assembly and configured to adjust an emergent direction of the emitted light beam emitted from the i-th light-emitting terminal over time to achieve beam-scanning.

15. The multi-channel LiDAR system according to claim 3, wherein the multi-channel LiDAR system further comprises:
a lens assembly configured to perform collimation and deflection on the emitted light beam emitted by an i-th light-emitting terminal of the N light-emitting terminals, and perform focusing on the reflected light beam to be coupled into an i-th light-receiving terminal of the N light-receiving terminals; and
a beam-scanning guiding apparatus on a side, away from the i-th light-emitting terminal and the i-th light-receiving terminal, of the lens assembly and configured to adjust an emergent direction of the emitted light beam emitted from the i-th light-emitting terminal over time to achieve beam-scanning.

16. The multi-channel LiDAR system according to claim 2, wherein the 1×N optical transmission apparatus comprises:
M stages of cascaded optical switch units, wherein each of the optical switch units comprises one input terminal and a plurality of output terminals, an output terminal of an optical switch unit in a j-th stage is connected to an input terminal of an optical switch unit 21 in a (j+1)-th stage in one-to-one correspondence, M and j are positive integers, M≥2, 1≤j<M;
an input terminal of an optical switch unit in a first stage is the one input terminal of the 1×N optical transmission apparatus, output terminals of optical switch units in the M-th stage are the N output terminals of the 1×N optical transmission apparatus.

17. The multi-channel LiDAR system according to claim 3, wherein the 1×N optical transmission apparatus comprises:
M stages of cascaded optical switch units, wherein each of the optical switch units comprises one input terminal and a plurality of output terminals, an output terminal of an optical switch unit in a j-th stage is connected to an input terminal of an optical switch unit 21 in a (j+1)-th stage in one-to-one correspondence, M and j are positive integers, M≥2, 1≤j<M;
an input terminal of an optical switch unit in a first stage is the one input terminal of the 1×N optical transmission apparatus, output terminals of optical switch units in the M-th stage are the N output terminals of the 1×N optical transmission apparatus.

18. The multi-channel LiDAR system according to claim 8, wherein each of the optical switch units comprises a first input terminal, a first output terminal and a second output terminal, and can be switched between a first switch state and a second switch state;
when the each of the optical switch units is in the first switch state, an optical path is formed between the first input terminal and the first output terminal and light blocking is formed between the first input terminal and the second output terminal;
when the each of the optical switch units is in the second switch state, an optical path is formed between the first input terminal and the second output terminal and light blocking is formed between the first input terminal and the first output terminal.

19. The multi-channel LiDAR system according to claim 9, wherein each of the optical switch units comprises a first input terminal, a first output terminal and a second output terminal, and can be switched between a first switch state and a second switch state;
when the each of the optical switch units is in the first switch state, an optical path is formed between the first input terminal and the first output terminal and light blocking is formed between the first input terminal and the second output terminal;
when the each of the optical switch units is in the second switch state, an optical path is formed between the first input terminal and the second output terminal and light blocking is formed between the first input terminal and the first output terminal.

20. The multi-channel LiDAR system according to claim 10, wherein each of the optical switch units comprises a first input terminal, a first output terminal and a second output terminal, and can be switched between a first switch state and a second switch state;
when the each of the optical switch units is in the first switch state, an optical path is formed between the first input terminal and the first output terminal and light blocking is formed between the first input terminal and the second output terminal;
when the each of the optical switch units is in the second switch state, an optical path is formed between the first input terminal and the second output terminal and light blocking is formed between the first input terminal and the first output terminal.
